(19) United States
(12) Patent Application Publication
(10) Pub. No.: US 2003/0182451 A1
(43) Pub. Date: Sep. 25, 2003

(54) Method and apparatus for converting voice over internet protocols

(76) Inventors: John B. Grass, Fremont, CA (US); Michael J. Vassallo, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/101,651

(22) Filed: Mar. 20, 2002

(51) Int. Cl. G06F 15/16

(52) U.S. Cl. 709/246

(57) ABSTRACT

A method and apparatus are provided for converting protocols between network devices. In one example, the method receives a message from a network device, wherein the message is structured in a particular protocol, and wherein the message is destined for another network device. It is then determined if the other network device is reachable. If the other network device is reachable, the other particular protocol required by the other network device is identified. The message is converted into a converted message that is structured in the other particular protocol. The converted message is then sent to the other network device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention generally relates to protocols for network devices and, more particularly, to techniques for converting protocols between network devices that communicate using a Voice over Internet Protocol (VoIP).

2. Discussion of Background

Voice over Internet Protocol (VoIP) is voice delivered using the Internet Protocol (IP). VoIP is a term used in IP telephony for a set of facilities for managing the delivery of voice information using the IP. In other words, VoIP products are a category of hardware and software that enables people to use the Internet as the transmission medium for telephone calls. In general, this means sending voice information in digital form in discrete packets rather than in the traditional circuit-committed protocols of the public switched telephone network (PSTN). A major advantage of VoIP and Internet telephony is that it takes advantage of data networks rather than telecommunications networks.

In VoIP, several different protocols exist that a network uses for signaling and voice transport. Two of the most prominent protocols are H.323 and Session Initiated Protocol (SIP).

H.323 is a standard arrived at by the International Telecom Union (ITU) intended to provide a foundation for audio, video, and data communication across data networks. H.323 can be said to be an umbrella standard that incorporates a number of standards. Thus, it is not specified by any single Request for Comments (RFC). H.323 has been around for a number of years and is widely deployed.

SIP, on the other hand, is relatively new, but is predicted to be the replacement of H.323. SIP is a brainchild of the Internet Engineering Task Force (IETF). The IETF's Multiparty Multimedia Session Control (MMUSIC) workgroup is working on SIP to make it a widely used protocol. SIP is much simpler than the H.323 standard and is often referred to as the HTML equivalent of Signaling. SIP is an application protocol that works on the Client-Server model, which means that for SIP there is a client and a server. The Client gives requests to the server and the server in turn provides the requested service. Each request and its corresponding reply is termed as a transaction. Each client is capable of receiving and sending a request.

Real-time voice between computers, once the hope and hype of the early pioneers, is presently an enthusiastically promoted component of most traditional networking companies' product line. Now providing improved voice quality (QoS) and acceptable reliability, VoIP is still plagued by lack of generally accepted inter-operability standards. For example, many VoIP network devices supporting H.323 do not inter-operate directly due to differences in implementation of the protocol by vendors of the network device.

FIG. 1 is a block diagram showing two VoIP network devices 102 in communication with each other using the same standard protocol. The standard protocol may be, for example, H.323 or SIP. A VoIP network device 102 can only communicate with another VoIP network device 102 that operates in the same protocol and the same protocol version. FIG. 1 illustrates how VoIP network devices support either H.323 or SIP, but not both. Thus, inter-operability problems arise when the protocols used by the VoIP network devices 102 are different.

A proposed solution has been to avoid inter-operability problems altogether. For example, vendors may deploy network devices from a single manufacturer. However, this approach merely avoids the inter-operability problem. It does not solve the problem.

### SUMMARY OF THE INVENTION

It has been recognized that what is needed is a technique for supporting inter-operability of VoIP network devices that communicate using different protocols. Broadly speaking, the present invention fills this need by providing a method and apparatus for converting protocols between VoIP network devices. It should be appreciated that the present invention can be implemented in numerous ways, including as a process, an apparatus, a system, a device or a method. Several inventive embodiments of the present invention are described below.

In one embodiment, a method is provided for converting protocols between network devices. The method comprises receiving a message from a network device, wherein the message is structured in a particular protocol, and wherein the message is destined for another network device; determining if the other network device is reachable; identifying the other particular protocol required by the other network device; converting the message into a converted message that is structured in the other particular protocol; and sending the converted message to the other network device.

In another embodiment, a protocol converter is provided configured to convert protocols between network devices. The protocol converter comprises a receiver device configured to receive a message from a network device, wherein the message is structured in a particular protocol, and wherein the message is destined for another network device; a determination device configured to determine if the other network device is reachable; an identifier device configured to identify the other particular protocol required by the other network device; a converter device configured to convert the message into a converted message that is structured in the other particular protocol; and a sender device configured to send the converted message to the other network device.

The invention encompasses other embodiments of a method, an apparatus, and a computer-readable medium, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram showing two VoIP network devices in communication with each other using the same protocol.

FIG. 2 is a block diagram showing the protocol converter in communication with two standard protocol network devices, in accordance with one embodiment of the present invention.

FIG. 3 is a block diagram showing the protocol converter in communication with a standard protocol network device and a proprietary protocol network device, in accordance with one embodiment of the present invention.

FIG. 4 is a block diagram showing the protocol converter in operation over a network, in accordance with one embodiment of the present invention.

FIG. 5 is a flowchart of a process for converting protocols between network devices, in accordance with one embodiment of the present invention.

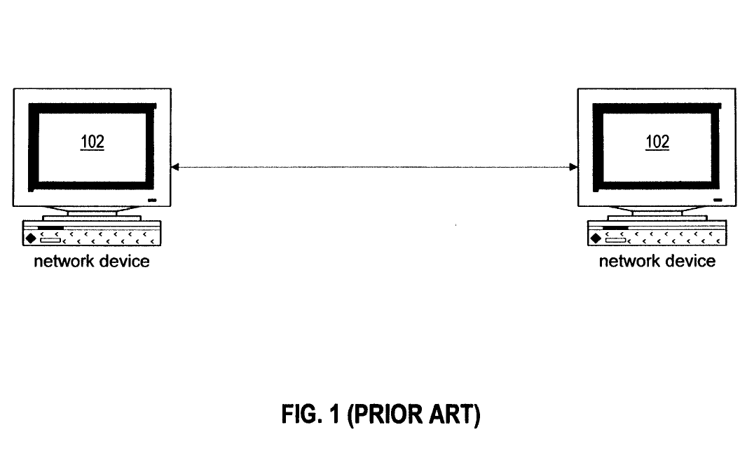

### DESCRIPTION OF THE PREFERRED EMBODIMENTS

An invention is disclosed for a method and apparatus for converting protocols between network devices. Numerous specific details are set forth in order to provide a thorough understanding of the present invention. It will be understood, however, to one skilled in the art, that the present invention may be practiced without some or all of these specific details.

General Overview

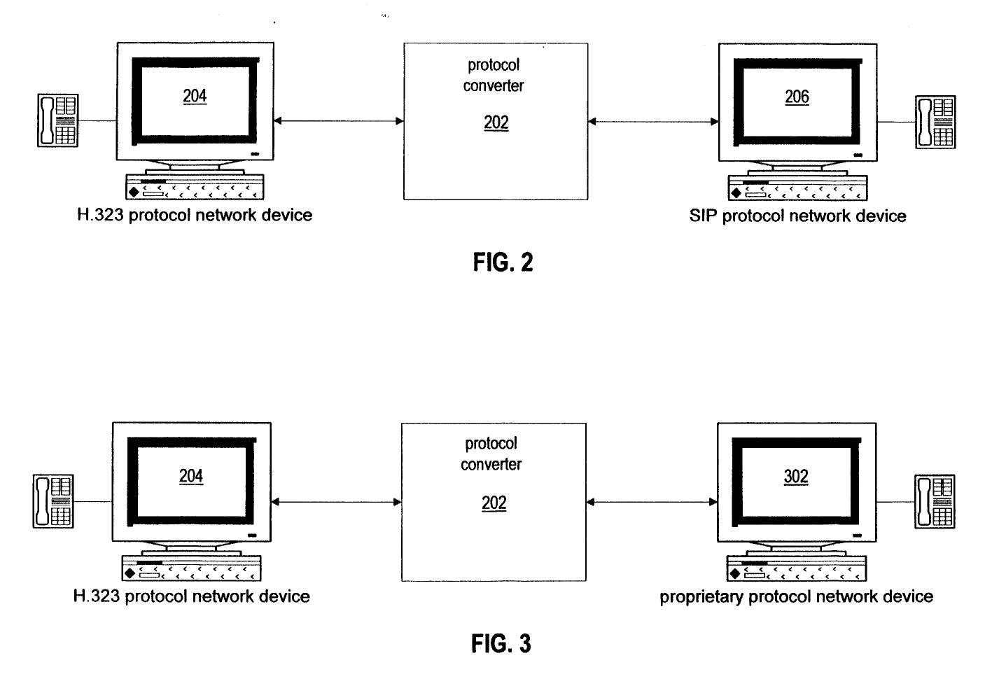

FIG. 2 is a block diagram showing the protocol converter 202 in communication with two standard protocol network devices, in accordance with one embodiment of the present invention. A standard protocol is a protocol having message structuring rules that are publicly known and commonly accepted in the programming industry.

The protocol converter 202 supports different manufacturer implementations of various standard protocols, such as H.323 and Session Initiated Protocol (SIP). An H.323 network device 204 and an SIP network device 206 are both in communication with the protocol converter 202. Although this embodiment includes a SIP network device 206 and an H.323 network device 204, the embodiment is not so limited only to these two standard protocols. The protocol converter can handle conversion of any standard protocol of any version, as long as the standard protocol is duly programmed into the protocol converter 202.

Accordingly, the protocol converter is capable of converting messages of one standard protocol into messages of another standard protocol. A Voice over Internet Protocol (VoIP) service provider can use different VoIP protocols within the same network. The VoIP service provider uses the protocol converter to switch between different VoIP protocols.

FIG. 3 is a block diagram showing the protocol converter 202 in communication with a standard protocol network device and a proprietary protocol network device, in accordance with one embodiment of the present invention. A proprietary protocol is a protocol having message structuring rules that are either not public or not commonly accepted in the programming industry.

The protocol converter 202 supports conversion between a standard protocol and various proprietary protocols. An H.323 network device 204 and a proprietary protocol network device 302 are both in communication with the protocol converter 202. Although this embodiment includes an H.323 network device 204, the embodiment is not so limited only to this standard protocol. The protocol converter can handle conversion between any standard protocol of any version and any proprietary protocol, as long as the protocol to be converted is duly programmed into the protocol converter 202.

In another embodiment, the protocol converter 202 supports conversion between a proprietary protocol and another proprietary protocol. In order to handle such conversion, the two different proprietary protocols are duly programmed into the protocol converter 202.

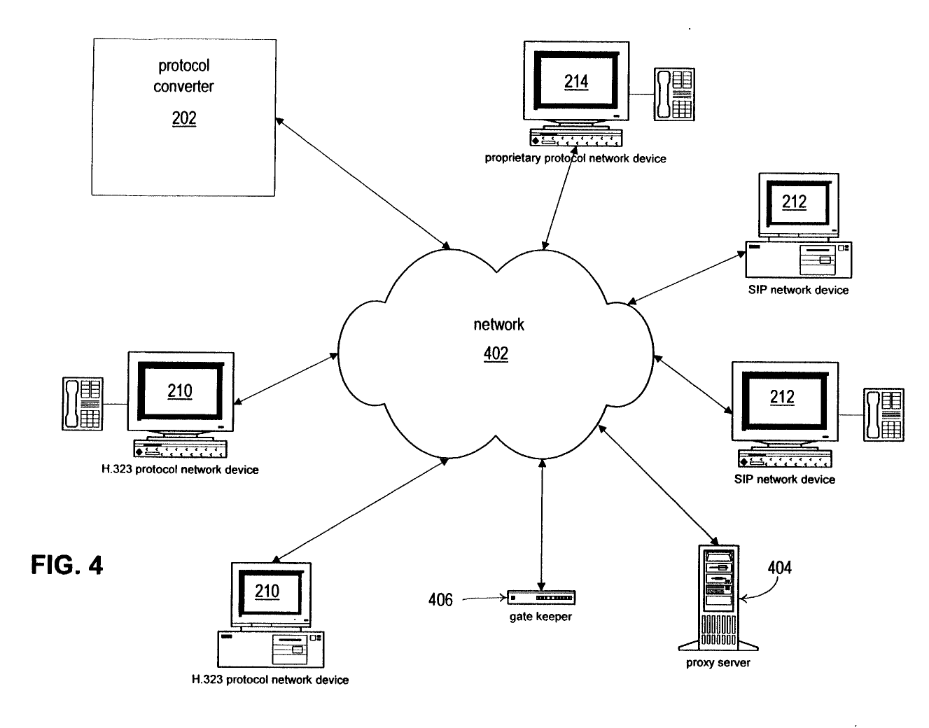

FIG. 4 is a block diagram showing the protocol converter 202 in operation over a network 402, in accordance with one embodiment of the present invention. The network 402 may be the Internet, which operates with the Internet Protocol (IP). In another embodiment the network 202 is an intranet, a local area network (LAN), or a wide area network (WAN).

The network 402 may handle communications between many different network devices, including a protocol converter 202, an H.323 network device 204, a SIP network device 206, a proprietary protocol network device 302, a proxy server 404, and a gate keeper 406.

Overview of Process

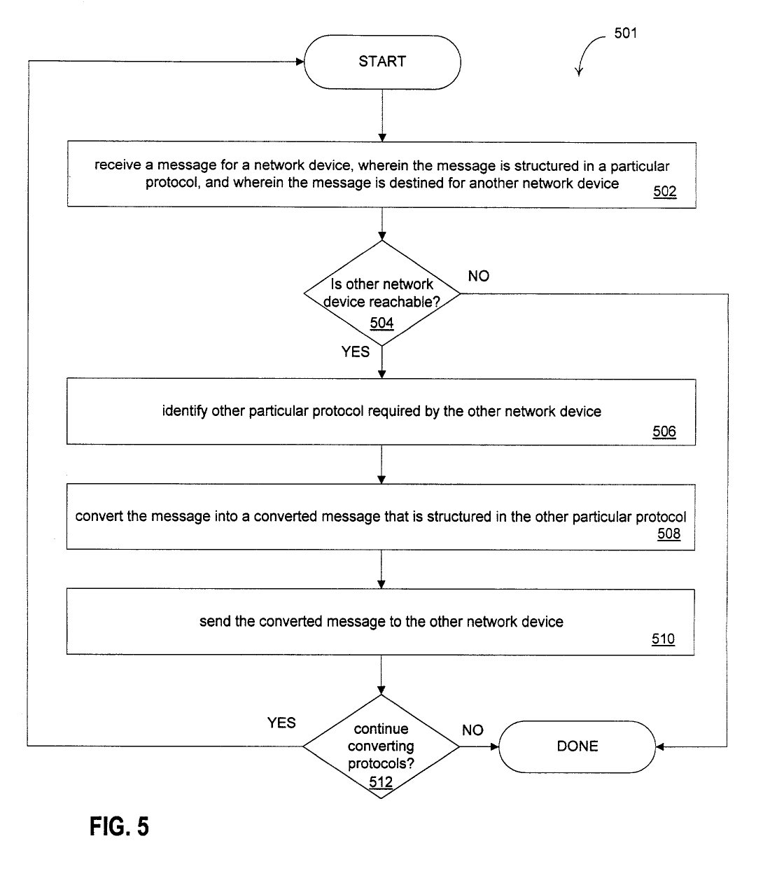

FIG. 5 is a flowchart of a process 501 for converting protocols between network devices, in accordance with one embodiment of the present invention. The process 501 starts in step 502 where the protocol converter 202 receives a message from a network device. The message is structured in a particular protocol and is destined for another network device. The protocol converter may receive multiple different messages from multiple different network devices. For explanation purposes, however, the following discussion will involve two network devices in communication with the protocol converter 202.

The process then moves to a decision operation 504 where it is determined if the other network device is reachable. If the other network device is not reachable, the process could proceed to try another route to the other network device, or the process could try to reach a completely different network device altogether. Otherwise, the process would be done at this point.

However, if the other network device is reachable, the process continues to step 506 where the protocol converter 202 identifies the other particular protocol that is required by the other network device. The other particular protocol may or may not be different than the particular protocol of the origin network device. If the protocols are the same, then the two network devices can be connected directly without utilizing the protocol converter 202.

However, if the protocols are different, the process moves to step 508 where the protocol converter 202 converts the message into a converted message. The converted message is structured in the other particular protocol, which is compatible with the other network device.

Proceeding to step 510, the protocol converter then sends the message to the other network device. The converted message is now in a suitable format to be read by the other network device.

The process 501 continues to decision operation 512 where it is determined if the protocol conversion is to continue. If protocol conversion is to continue with additional messages, the process 501 returns to step 502 where the protocol converter 202 receives another message from a network device. However, if protocol conversion is not to continue, the process 501 is done.

System and Method Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, receiving a message from a network device, determining if another network device is reachable, identifying another particular protocol required by the other network device, converting the message into a converted message that is structured in the other particular protocol, and sending the converted message to the other network device, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of converting protocols between network devices, the method comprising:
receiving a message from a network device, wherein the message is structured in a particular protocol, and wherein the message is destined for another network device;
determining if the other network device is reachable;
identifying the other particular protocol required by the other network device;
converting the message into a converted message that is structured in the other particular protocol; and
sending the converted message to the other network device.

2. The method of claim 1, wherein the message is one of:
a setup request configured to initiate communication with the other network device;
a progress message; and
an informational message.

3. The method of claim 1, wherein the message is a hangup signal configured to terminate communication with the other network device.

4. The method of claim 1, wherein the step of receiving a message includes receiving the message over Internet Protocol (IP), and wherein the step of sending the converted message includes sending the converted message over Internet Protocol.

5. The method of claim 4, wherein the particular protocol is a Voice over Internet Protocol (VoIP) configured to transmit one of:
video signals;
telephone signals; and
streaming video signals.

6. The method of claim 1, wherein the particular protocol is H.323 and the other particular protocol is Session Initiated Protocol (SIP).

7. The method of claim 1, wherein the particular protocol is one of H.323 and Session Initiated Protocol (SIP), and wherein the other particular protocol is a non-standard, proprietary protocol.

8. The method of claim 1, wherein the particular protocol is a non-standard, proprietary protocol, and wherein the other particular protocol is another non-standard, proprietary protocol.

9. A protocol converter configured to convert protocols between network devices, the protocol converter comprising:
a receiver device configured to receive a message from a network device, wherein the message is structured in a particular protocol, and wherein the message is destined for another network device;
a determination device configured to determine if the other network device is reachable;
an identifier device configured to identify the other particular protocol required by the other network device;
a converter device configured to convert the message into a converted message that is structured in the other particular protocol; and
a sender device configured to send the converted message to the other network device.

10. The protocol converter of claim 9, wherein the protocol converter is an application specific integrated circuit (ASIC).

11. The protocol converter of claim 9, wherein the message is a setup request configured to initiate communication with the other network device.

12. The protocol converter of claim 9, wherein the message is a hangup signal configured to terminate communication with the other network device.

13. The protocol converter of claim 9, wherein the receiver device is configured to receive the message over Internet Protocol (IP), and wherein the sender device is configured to send the converted message over Internet Protocol.

14. The protocol converter of claim 13, wherein the particular protocol is a Voice over Internet Protocol (VoIP) configured to transmit one of:
video signals;
telephone signals; and
streaming video signals.

15. The protocol converter of claim 9, wherein the particular protocol is H.323 and the other particular protocol is Session Initiated Protocol (SIP).

16. The protocol converter of claim 9, wherein the particular protocol is one of H.323 and Session Initiated Protocol (SIP), and wherein the other particular protocol is a non-standard, proprietary protocol.

17. The protocol converter of claim 9, wherein the particular protocol is a non-standard, proprietary protocol, and wherein the other particular protocol is another non-standard, proprietary protocol.

18. A computer-readable medium carrying one or more sequences of one or more instructions for converting protocols between network devices, the one or more sequences of one or more instructions including instructions which, when executed by one or more processors, cause the one or more processors to perform the steps of:
receiving a message from a network device, wherein the message is structured in a particular protocol, and wherein the message is destined for another network device;
determining if the other network device is reachable;
identifying the other particular protocol required by the other network device;
converting the message into a converted message that is structured in the other particular protocol; and
sending the converted message to the other network device.

19. The computer-readable medium of claim 18, wherein the message is a setup request configured to initiate communication with the other network device.

20. The computer-readable medium of claim 18, wherein the message is a hangup signal configured to terminate communication with the other network device.

21. The computer-readable medium of claim 18, wherein the step of receiving a message further causes the processors to carry out the step of receiving the message over Internet Protocol (IP), and wherein the step of sending the converted message further causes the processors to carry out the step of sending the converted message over Internet Protocol.

22. The computer-readable medium of claim 21, wherein the particular protocol is a Voice over Internet Protocol (VoIP) configured to transmit one of:
video signals;
telephone signals; and
streaming video signals.

23. The computer-readable medium of claim 18, wherein the particular protocol is H.323 and the other particular protocol is Session Initiated Protocol (SIP).

24. The computer-readable medium of claim 18, wherein the particular protocol is one of H.323 and Session Initiated Protocol (SIP), and wherein the other particular protocol is a non-standard, proprietary protocol.

25. The computer-readable medium of claim 18, wherein the particular protocol is a non-standard, proprietary protocol, and wherein the other particular protocol is another non-standard, proprietary protocol.
